(19) United States
(12) Patent Application Publication
(10) Pub. No.: US 2025/0286584 A1
(43) Pub. Date: Sep. 11, 2025

(54) SMART REFLECTING ELEMENTS SELECTION WITH NWDAF IN RIS-AIDED URLLC SYSTEMS

(71) Applicant: LENOVO (BEIJING) LIMITED, BEIJING (CN)

(72) Inventors: TINGNAN BAO, BEIJING (CN); JIANFENG WANG, BEIJING (CN); TINGFANG TANG, BEIJING (CN); HAIMING WANG, BEIJING (CN)

(21) Appl. No.: 18/721,172

(22) PCT Filed: Dec. 16, 2021
(86) PCT No.: PCT/CN2021/138644

§ 371 Date: Jun. 17, 2024

(51) Int. Cl. H04B 7/04

(52) U.S. Cl. CPC H04B 7/04013

(57) ABSTRACT

Methods and apparatuses for smart selecting reflecting elements with a network apparatus (e.g., network data analytics function (NWDAF)) in re-configurable intelligent surface (RIS)-aided URLLC (ultra-reliable and low-latency communication) system are disclosed. A method comprises transmitting, to a network apparatus, parameters necessary to determine an active number of reflecting elements at an RIS between the base station and a UE in an RIS-aided URLLC system; and receiving the active number of reflecting elements from the network apparatus.

### FIELD

The subject matter disclosed herein generally relates to wireless communications, and more particularly relates to methods and apparatuses for smart selecting reflecting elements with NWDAF in re-configurable intelligent surface (RIS)-aided URLLC system.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Reconfigurable Intelligent Surface (RIS), enhance mobile broadband (eMBB), massive machine-type communication (mMTC), ultra-reliable and low-latency communication (URLLC), internet-of-things (IoT), narrow-band Internet of Things (NB-IoT), augmented reality (AR), virtual reality (VR), Large Intelligent Surface (LIS), Intelligent Reflecting Surface (IRS), electromagnetic (EM), radio frequency (RF), channel state information (CSI), multiple input multiple output (MIMO), base station (BS), sounding reference signal (SRS), standalone (SA), network functions (NF), network data analytics function (NWDAF), machine learning (ML), artificial intelligence (AI), alternate optimization (AO), delay outage rate (DOR), average decoding error probability (ADEP), cumulative distribution function (CDF), service-based architecture (SBA), Access and Mobility management function (AMF), transmission-reception point (TRP).

With the incredible increase in the number of devices and new applications that require wireless connectivity, the evolution of wireless communications is needed to support higher data rate, larger capacity, and lower cost. Three main types of services have been designed in the fifth generation (5G) networks to fulfil the demand: enhance mobile broadband (eMBB), massive machine-type communication (mMTC), and ultra-reliable and low-latency communication (URLLC). eMBB can provide higher capacity and faster data rate. mMTC can provide the services for narrow-band Internet of Things (NB-IoT). Different from eMBB and mMTC, URLLC can support mission-critical cases in factory automation, real-time control, augmented reality or virtual reality (AR/VR)-based applications and consumer-oriented services. With NR Release 16, different mission-critical cases have different latency time and various link reliabilities. For example, augmented worker requires a packet loss rate lower than 10⁻⁴ and end-to-end latency of less than 10 ms to ensure mission-critical communications. For another example, factory automation applications require a packet loss rate lower than 10⁻⁹ and end-to-end latency of less than 1 ms to ensure mission-critical communications. Moreover, Shannon's capacity bound is not applicable for URLLC since coding is performed under an infinite blocklength in traditional wireless communication, while URLLC needs to transmit short packets under a finite blocklength regime to reduce the latency. Thus, a complementary solution to achieve high reliability and low latency requirements simultaneously is necessary to transmit short packets for URLLC.

Reconfigurable Intelligent Surface (RIS), which can be alternatively referred to as Large Intelligent Surface (LIS), Intelligent Reflecting Surface (IRS) or Intelligent Metasurface, is an emerging technology. RIS is a large and thin metasurface of metallic or dielectric material, comprised of an array of passive sub-wavelength scattering elements with specially designed physical structure. The elements can be controlled in a software-defined manner to change the electromagnetic (EM) properties (e.g. phase shift and amplitude attenuation, each of which can be referred to as a coefficient) of the reflection of the incident radio frequency (RF) signals. By a joint control of the coefficients of all scattering elements, the reflected radiation pattern (e.g. phase, amplitude or polarization) of the incident RF signals can be arbitrarily tuned in real time, thus creating new degrees of freedom to the optimization of the overall wireless network performance. RIS can real-time control the response of electromagnetic wave effectively, and is considered as one of the potential key technologies for the sixth generation (6G) systems.

Although more active elements at an RIS bring potential better performance, e.g., higher reliability, the overhead to obtain such benefit is increased. For example, the channel estimation procedure using more pilot signals always breaks the limitation on the latency requirement. Thus, the RIS deployment is necessary to be carefully designed for an URLLC application with the requirements on both high reliability and low latency. RIS-aided URLLC systems can provide lower latency when URLLC employs mmWave or terahertz (THz) technique.

A typical deployment of RIS in a modern mobile communication system (e.g. RIS-aided URLLC system in a smart factory) is illustrated in FIG. 1, where the RIS (e.g. located on the wall or the ceiling of the smart factory) is controlled by a base station (BS), e.g. gNB or TRP, via a dedicated interface (note that the interface may be defined if the RIS is regarded as a new node category in 6G networks). The RIS forwards the signal from the BS to the target user equipment (UE), e.g. an automatic robot. That is, the RIS forms a cascaded channel between the BS and the UE. The propagation path BS-RIS-UE can be tuned by the selected reflection coefficients in the elements to satisfy some requirements, such as coverage and higher received power. Due to RIS's passive feature, it is challenging to obtain perfect channel state information (CSI). Typically, the current beamforming design for RIS-aided communications should be estimated. The number of the channel coefficients is in total K×M×N+K×M, where K, N and M denote the number of antennas at UE users, the number of reflecting elements at the RIS, and the number of antennas at the BS, respectively, which can be large, especially in a massive MIMO system.

In the working phase, the RIS would receive and then re-radiate (i.e., reflect) the radio signals from the BS (e.g. gNB), and the controller within the RIS configures the amplitudes and phase shifts of all active elements in real-time by receiving dedicated signals from the BS. As the key issue in this RIS-aided communication, the CSI between these three nodes (between gNB and UE, between gNB and RIS, between RIS and UE) should be well estimated by gNB to obtain the expected coefficients. The typical derivation procedure is shown in FIG. 2, where the gNB requests the target UE to send reference signals to assist channel estimation. The reference signals should cover all elements (which can be also referred to as reflecting elements) at the RIS for gNB to calculate the expected coefficients. Once the values are derived, gNB would assign the values to the RIS for the following communication with the target UE.

For example, as a typical setting in 5G, if there are 32 antennas at gNB (M=32) and 4 antennas at UE (K=4), respectively, the 64 elements at RIS (N=64) can result in a total of 8320 channel coefficients to be estimated, which is a huge number for the reference signals, such as sounding reference signal (SRS) or CSI-RS, in the time domain. Thus, much more time is needed to obtain the coefficients before the next transmission, which is not expected for the URLLC application.

With the increasing mission-critical IoT and applications over URLLC, the traditional cellular network tends to be more complex. As an evolution from the fourth generation (4G), 3GPP released 5G standalone (SA) introduces the new IoT user cases in an evolved packet core network. Besides, data analytics play an important role in 5G SA, which is designed to support gigabit data rates. As such, the network data analytics function (NWDAF) is a newly proposed data analytics function and provides the interaction with other network functions (NF) in 5G networks. As such, machine learning (ML) algorithm or other artificial intelligence (AI) algorithm can be implemented in NWDAF to analyze the network data.

This invention targets selecting the number of active reflecting elements at RIS by NWDAF to achieve low computational time, high reliability and low latency requirements, simultaneously.

### BRIEF SUMMARY

Methods and apparatuses for smart selecting reflecting elements with a network apparatus (e.g. NWDAF) in re-configurable intelligent surface (RIS)-aided URLLC system are disclosed.

In one embodiment, a method comprises transmitting, to a network apparatus, parameters necessary to determine an active number of reflecting elements at an RIS between the base station and a UE in an RIS-aided URLLC system; and receiving the active number of reflecting elements from the network apparatus. In one embodiment, the network apparatus is the NWDAF.

In one embodiment, the method further comprises setting the active number of reflecting elements to the RIS.

In some embodiment, the parameters are for determining the active number of reflecting elements by applying DOR metric in the RIS-aided URLLC system. The parameters may include DOR requirement(s) of user group(s) and user traffic parameters. The user traffic parameters may include at least received SNR, the type of the traffic, required bandwidth, data rate, and the volume of transmitted data.

In some embodiment, the parameters are transmitted via an AMF.

In another embodiment, a base station comprises a transmitter that transmits, to a network apparatus, parameters necessary to determine an active number of reflecting elements at an RIS between the base station and a UE in an RIS-aided URLLC system; and a receiver that receives the active number of reflecting elements from the network apparatus.

In yet another embodiment, a method comprises receiving, from the base station, parameters necessary to determine an active number of reflecting elements at an RIS between a base station and a UE in an RIS-aided URLLC system; determining the active number of reflecting elements according to the received parameters; and transmitting the active number of reflecting elements to the base station.

In a further embodiment, a network apparatus comprises a receiver that receives, from the base station, parameters necessary to determine an active number of reflecting elements at an RIS between a base station and a UE in an RIS-aided URLLC system; a processor that determines the active number of reflecting elements according to the received parameters; and a transmitter that transmits the active number of reflecting elements to the base station.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a typical deployment of RIS in a modern mobile communication system;

FIG. 2 illustrates a typical derivation procedure;

FIG. 3 illustrates an RIS-aided URLLC system in a radio access network (RAN) and associated service-based architecture;

FIG. 4 illustrates interfaces between NWDAF and other NF;

FIG. 5 illustrates a signaling and data exchange processes of a method according to this disclosure;

FIG. 6 is a schematic flow chart diagram illustrating an embodiment of a method;

FIG. 7 is a schematic flow chart diagram illustrating an embodiment of another method; and

FIG. 8 is a schematic block diagram illustrating apparatuses according to one embodiment.

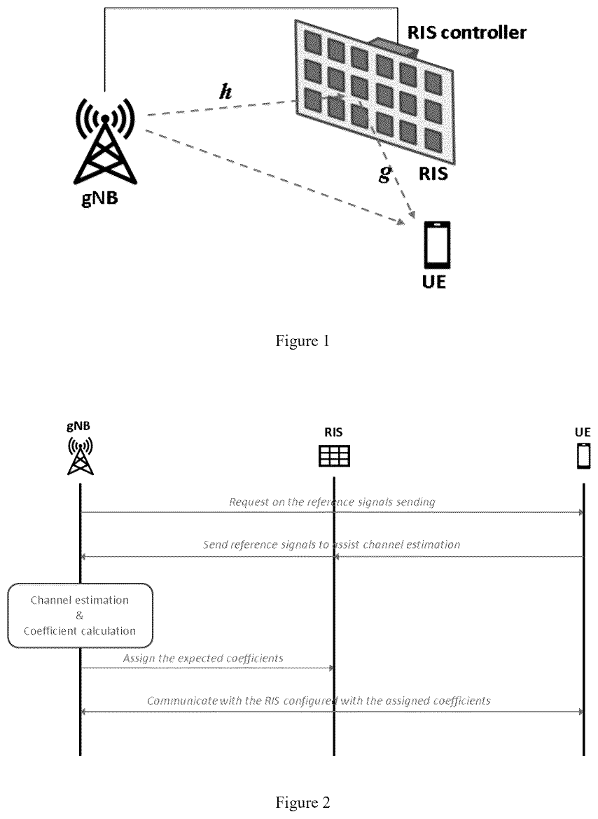

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”.

The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, comprise the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code.

This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Many research works have investigated the design of joint transmission beamforming at the gNB and phase shifts at RIS to provide the system performance. Since most of the actual RIS can only achieve low-precision phase shifting, there is no best solution to the problem for the design of joint transmission beamforming at the gNB and phase shifts at RIS. Using alternate optimization (AO) method, the joint optimization problem is divided into two sub-problems of gNB active beamforming and RIS passive beamforming. The local optimal solutions are solved separately through different algorithms including semi-definite relaxation method, branch and bound method, iterative algorithm and quantification method. In the working phase, the RIS would reflect the received signal from the gNB to the target UE, and gNB informs the controller within the RIS to configure the amplitudes and phase shifts of all active elements in real-time. The inventors note that the optimal amplitudes and phase shifts for all reflecting elements rely on those high-complexity optimization algorithms. With the increasing reflecting elements of RIS, the achievement of the accurate channel state information (CSI) causes huge pilot overhead and limits the actual deployment of RIS.

URLLC systems employ finite blocklength to transmit short packets. The finite blocklength capacity formula leads to a challenging task. However, the performance analysis of a conventional RIS-related wireless communication cannot directly apply to URLLC systems.

A new data-oriented performance metric, i.e., the performance analysis of delay outage rate (DOR) under Rayleigh fading channel, is studied. Besides, the performance on the average rate and average decoding error probability (ADEP) of RIS-aided short packet communication by the approximation with Gamma distribution for the channel model has been investigated. Due to the unique requirements including the ultra-high reliability, low latency, and high energy efficiency for URLLC, the previous work considered all reflecting elements of RIS, which leads to huge overhead, is inapplicable. Thus, a feasible number of reflecting elements of RIS is required for RIS-aided URLLC systems.

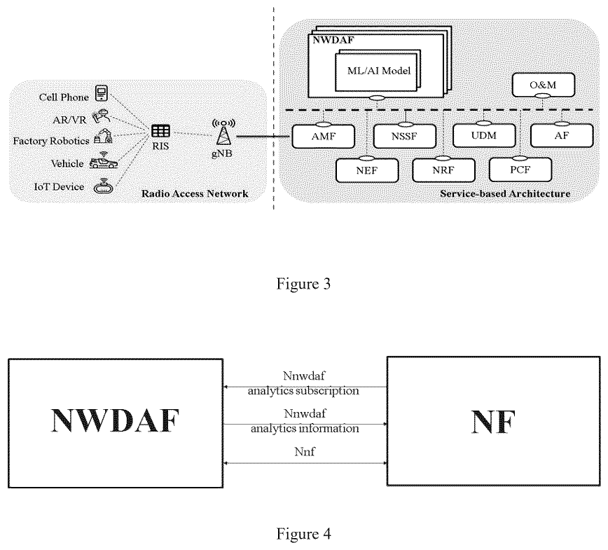

FIG. 3 illustrates an RIS-aided URLLC system in a radio access network (RAN), where a base station (e.g., gNB) transmits the signal to a target user in the set of user case groups with the help of the RIS. It is assumed that the RIS has N reflecting elements, located on the wall or building in the coverage of the gNB. The RIS is controlled by the gNB via a dedicated interface. The interface may be defined when the RIS is a new entity in 6G networks.

For the sake of simplicity, even though many more types of user case groups can be supported, in the example of FIG. 3, only five types of user case groups for the URLLC system (including cell phone, augmented reality (AR)/virtual reality (VR), factory robotics, vehicle and IoT device) are shown.

To jointly evaluate the high reliability and low latency for different URLLC applications, DOR may be used as a performance metric to obtain the feasible reflecting elements of RIS. Specifically, DOR is defined as the probability that the delivery time T_{D} which has successfully transmitted a certain amount of data in a wireless channel is higher than a delay threshold duration Tₜₕ:

$$DOR = Pr [ {T}_{D} > {T}_{th} ] \qquad ( Equation 1 )$$

where

$${T}_{D} = \frac{H}{{R}_{D}} ,$$

H is the amount of data in bits; R_{D} is the actual rate for the transmission and R_{D} depends on the channel blocklength W and achievable block error probability ε.

In particular,

$${R}_{D} = C ( γ ) - {Q}^{- 1} ( ε ) \sqrt{\frac{V ( γ )}{W}} + 𝒪 ( \frac{{log}_{2} ( γ )}{W} ) ,$$

where C(γ)=Blog₂ (1+γ) is the maximum instantaneous transmission rate from Shannon capacity theorem with bandwidth B; V(γ) is channel dispersion measuring the stochastic variability of the channel with respect to a deterministic channel; Q⁻¹(·) is the inverse of Q-function; and O(·) is the higher order terms of Taylor series.

As a whole, the Equation 1 can be rewritten as Equation 2:

$$DOR = Pr [ γ < {2}^{\frac{H}{B {T}_{th}} + \frac{{Q}^{- 1} ( ε )}{B} \sqrt{\frac{V ( γ )}{W}} + 𝒪 ( \frac{{log}_{2} ( γ )}{W} )} - 1 ] = {F}_{γ} [ {2}^{\frac{H}{B {T}_{th}} + \frac{{Q}^{- 1} ( ε )}{B} \sqrt{\frac{V ( γ )}{W}} + 𝒪 ( \frac{{log}_{2} ( γ )}{W} )} - 1 ] , \qquad ( Equation 2 )$$

where, F_{γ}(·) is the cumulative distribution function (CDF) of received SNR γ.

For an RIS-aided URLLC system, the CDF of the received SNR is related to the number of feasible reflecting elements at the RIS. It is assumed that each of gNB and a target user from the set of user case groups uses a single antenna. During transmission between gNB and the target user, gNB sends the original signal to RIS via the channel h, and subsequently, the RIS reflects the received signal to the target user via the channel g. As such, the received signal at the target user is given by: y=\sqrt{P}(Eᵢ₌₁^{N}hᵢξe^{jϕi}gᵢ)x+n₀,

where P is the transmit power at gNB, x is the transmit symbol with unit power and n₀ is the additive white Gaussian noise with the mean of zero and the variance of N₀. The channel gain hᵢ can be expressed as hᵢ=dₕ_{ᵢ}^{-∈/2}αᵢe^{-jθ}^{ᵢ}, where dₕ_{ᵢ} is the distance from gNB to RIS, ∈ is the path-loss exponent, αᵢ and θᵢ are the amplitude and the phase of the channel gain. The channel gain gᵢ can be expressed as gᵢ=d_{g}_{ᵢ}^{-∈/2}βᵢe^{-jφ}^{ᵢ}, where da, is the distance from RI S to the target user, Bᵢ and φᵢ are the amplitude and the phase of the channel gain. In addition, ξᵢe^{jθ}^{ᵢ} is the iₜₕ reflection coefficient, where ξᵢ=1 for the ideal phase shifts ϕᵢ ∈[0,2π] with i=1,2, . . . , N.

Accordingly, the instantaneous received SNR at the target user can be obtained

$$as γ = \frac{P {\vert {\sum }_{i = 1}^{N} {α}_{i} {β}_{i} {e}^{j ( {∅}_{i} - {θ}_{i} - {φ}_{i} )} \vert}^{2}}{{N}_{0} {d}_{{h}_{i}}^{ϵ} {d}_{{g}_{i}}^{ϵ}} = {( {\sum }_{i = 1}^{N} {α}_{i} {β}_{i} {e}^{j {ψ}_{i}} )}^{2} \overline{γ} ,$$

where y̅=P/N₀dₕ_{ᵢ}^{W}d_{g}_{ᵢ}^{W} is the average SNR, the phase error ψᵢ=ϕᵢ−θ₁−qᵢ occurs due to the hardware impairment. Since αᵢβᵢe^{jψi} is the random variables for the i^{th} cascaded channel, the CDF of received SNR can be obtained as a function of the reflecting elements of RIS, which is related to Equation 2. When the requirement for a URLLC application is known, the feasible number of reflecting elements of RIS can be obtained. For example, AR/VR applications require a packet loss rate lower than 10⁻⁶ and end-to-end latency less than 10 ms to ensure mission-critical communications. For RIS-aided URLLC system, according to the Equation 2, DOR is equal to 10⁻⁴ and a delay threshold Th is equal to 10 ms. After setting system parameters, the feasible number (i.e., M (M≤N)) reflecting elements of the RIS can be obtained to reduce overhead. However, we note that wireless channels experience various fading effects, such as Rician fading or Nakagami-m fading. The fading will increase the computational complexity and computation time to obtain the expression of the CDF of the received SNR and further obtain the feasible number (i.e. M) of reflecting elements.

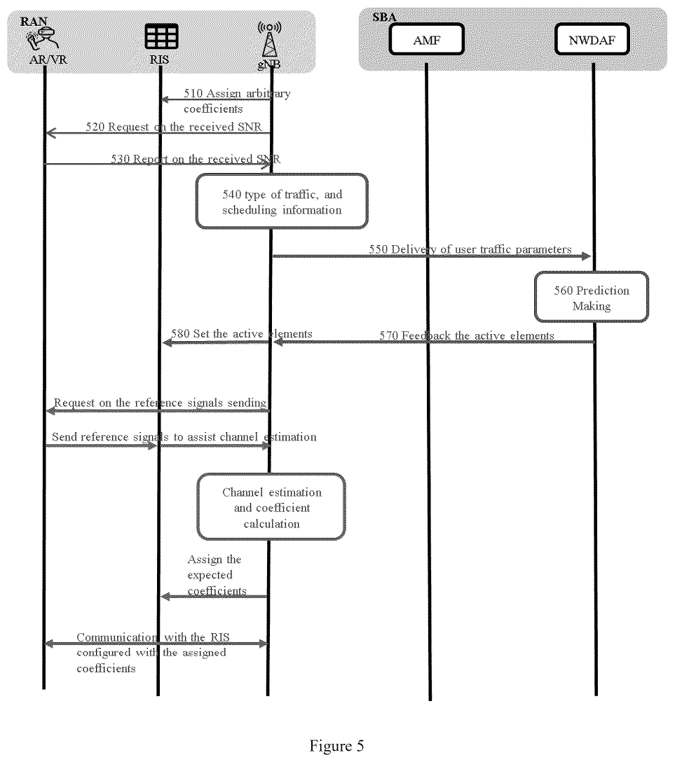

ML/AI models can be used to determine the feasible number (i.e., M) of reflecting elements under RIS-aided URLLC systems. As depicted in FIG. 3, data connectivity and services can be exchanged between RAN and service-based architecture (SBA). In SBA, NWDAF with native ML/AI models can provide network analysis to other network functions (NFs). NWDAF transfers data with other NFs (e.g. AMF) via the service-based interface (SBI), represented by Nnwdaf and Nnf, as shown in FIG. 4.

There are two Nnwadf services including analytics subscription and analytics information. We can consider Nnwdaf analytics subscription as charging services, Nnwdaf analytics information as applying ML/AI models, and Nnf as gathering data from other NFs.

According to this disclosure, when the data is transferred from RAN into the SBA, NWDAF can fetch the information from other NFs and apply ML/AI models to predict the feasible number (i.e. M) of reflecting elements.

Since there are many MI/AL models working for different proposes, supervised ML algorithm is considered as an example to determine the feasible number (i.e., M) of reflecting elements. If the supervised ML algorithm is used in NWDAF to determine (e.g., predict) the feasible number (i.e., M) of reflecting elements, the following parameters will be the input:

User case groups IDs and names of the device types;

Initial load configurations including packet loss rate (DOR) and latency (Th), which represent the URLLC requirements per use case group; and
Other necessary system parameters: including the received SNR, bandwidth B, the amount of transmitted data H, the channel block-length W, the achievable block error probability ε, the transmit power P, the path-loss exponent CO, the distance for gNB-RIS and RIS-target user, the additive white Gaussian noise with the mean of zero and the variance of No, and total reflecting elements at RIS (i.e., N).

The URLLC requirements for different use case groups as initial load configurations are shown in Table 1.

TABLE 1

| Use Case Group | Latency | | Reliability |
|---|---|---|---|
| Cell Phone | 1 | ms | 10⁻¹ |
| AR/VR | 10 | ms | 10⁻⁶ |
| Factory Robotics | 1 | ms | 10⁻⁸ |
| Vehicle | 10 | ms | 10⁻⁵ |
| IoT Device (Smart Grid ) | 10 | ms | 10⁻⁷ |

It can be seen from Table 1 that different initial load is assigned for each type of use case groups. The initial load configurations for all types of use case groups can be transmitted and stored in the NWDAF previously to the method illustrated in FIG. 5.

An example of the method according to this disclosure is shown in FIG. 5.

In step 510, the gNB assigns arbitrary coefficients to the RIS. The step 510 is optional. In practice, the arbitrary coefficients can be assigned by doing nothing.

In step 520, the gNB requests the UE to report the received SNR. For example, the step 520 can be implemented in the random access process or paging information. In particular, the gNB transmits pilot signals to the UE, and requires the UE to report the received SNR based on the pilot signals.

The UE calculates received SNR of the pilot signals based on channel conditions. In step 530, the UE reports the received SNR. For example, the received SNR can be contained in access request in the random access process. The gNB obtains the received SNR.

In step 540, the gNB obtains predefined URLLC related system parameters, e.g. type of traffic (e.g., an index of the user case group) and scheduling information. The scheduling information is for example channel bandwidth (B), the amount of data (H), and other data in the Equation 2.

In step 550, the gNB transmits user traffic parameters to NWDAF via Access and Mobility management function (AMF). The user traffic parameters may include the received SNR, the type of traffic, and the scheduling information. The type of traffic indicates a user case group, which identifies the DOR requirement of the user case group (or of the type of traffic). Incidentally, if the initial load configurations for all types of use case groups were not previously transmitted to and stored in the NWDAF, the type of traffic may be replaced by the DOR requirement (e.g. latency and reliability) for the type of traffic. AMF acts as a gateway network device in the 5G core network. UE associated signaling between gNB and AMF via N2 interface was established when the UE was initially connected into the network. A new message or re-used legacy message (e.g., UE information transfer message) can be used to transmit the user traffic parameters from gNB to AMF via N₂ interface. The NWDAF can fetch these data (e.g., by Nnf) and store them in a “Data Repository” for analysis (e.g., for determining the active reflecting elements at RIS).

When the received data from AMF is transferred to NWDAF by NWDAF subscribing at AMF Event Exposure Services, in step 560, the NWDAF (e.g., the “Analyzer” inside of the NWDAF) uses its trained ML/AI model (e.g., supervised ML algorithm) to predict (or determine) the active reflecting elements at RIS (the feasible number M of reflecting elements at RIS).

In step 570, the NWDAF transmits the predicted data (e.g., the number of M, or the number of active reflecting elements) to the gNB. For example, the predicted data from NWDAF will be delivered to the AMF by using the Nnwdaf analytics information. Then, the AMF transmits the predicted data (e.g., the number of active reflecting elements) to the gNB.

In step 580, the gNB sets the number of active reflecting elements at RIS according to the predicted value. In particular, the active number (e.g., M) is transmitted to the RIS controller.

The following steps for channel estimation and expected coefficients derivation are the same as the prior-art procedure (e.g., the procedure illustrated in FIG. 2).

According to the present disclosure, the total time consumption for calculating the active number of elements in RIS can be reduced with the help of NWDAF. The pilot overhead can be also reduced if only a part of full number (M out of N) of elements is used. By introducing ML approaches in NWDAF system, lower system time consumption can be guaranteed. In addition, high reliability and low latency for RIS-aided URLLC systems can be maintained.

In the above described method, the supervised ML algorithm in the NWDAF predicts the active number of reflecting elements at RIS. It is apparent that other ML/AI models, if applicable, can be used to predict the active number of reflecting elements at RIS.

The above description describes determining the active number of reflecting elements at RIS by using DOR as performance metric. It is feasible that other performance metric(s) can be used. In this condition, the parameters for determining an active number of reflecting elements at RIS related to other performance metric(s) can be transmitted to the NWDAF, and the NWDAF determines the active number of reflecting elements at RIS according to the received parameters using a feasible ML/AI algorithm for the other performance metric(s).

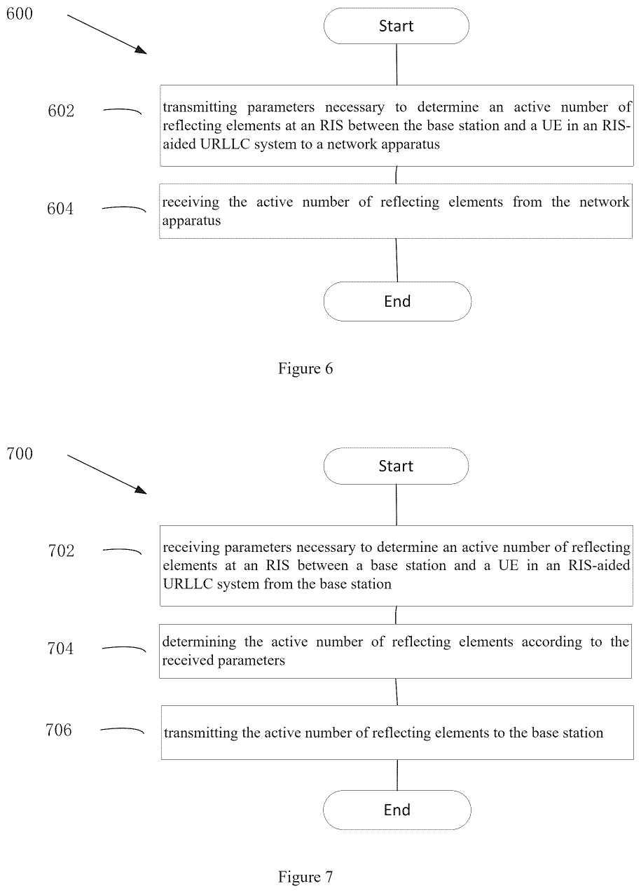

FIG. 6 is a schematic flow chart diagram illustrating an embodiment of a method 600 according to the present application. In some embodiments, the method 600 is performed by an apparatus, such as a base station. In certain embodiments, the method 600 may be performed by a processor executing program code, for example, a microcontroller, a microprocessor, a CPU, a GPU, an auxiliary processing unit, a FPGA, or the like.

The method 600 may comprise 602 transmitting, to a network apparatus, parameters necessary to determine an active number of reflecting elements at an RIS between the base station and a UE in an RIS-aided URLLC system; and 604 receiving the active number of reflecting elements from the network apparatus. In one embodiment, the network apparatus is the NWDAF.

In one embodiment, the method 600 further comprises setting the active number of reflecting elements to the RIS.

In some embodiment, the parameters are for determining the active number of reflecting elements by applying DOR metric in the RIS-aided URLLC system. The parameters may include DOR requirement(s) of user group(s) and user traffic parameters. The user traffic parameters may include at least received SNR, the type of the traffic, required bandwidth, data rate, and the volume of transmitted data.

In some embodiment, the parameters are transmitted via an AMF.

FIG. 7 is a schematic flow chart diagram illustrating an embodiment of a method 700 according to the present application. In some embodiments, the method 700 is performed by a network apparatus, such as NWDAF. In certain embodiments, the method 700 may be performed by a processor executing program code, for example, a microcontroller, a microprocessor, a CPU, a GPU, an auxiliary processing unit, a FPGA, or the like.

The method 700 may comprise 702 receiving, from the base station, parameters necessary to determine an active number of reflecting elements at an RIS between a base station and a UE in an RIS-aided URLLC system; 704 determining the active number of reflecting elements according to the received parameters; and 706 transmitting the active number of reflecting elements to the base station.

In some embodiment, the parameters are for determining the active number of reflecting elements by applying DOR metric in the RIS-aided URLLC system. The parameters may include DOR requirement(s) of user group(s) and user traffic parameters. The user traffic parameters may include at least received SNR, the type of the traffic, required bandwidth, data rate, and the volume of transmitted data.

In some embodiment, the parameters are received via an AMF.

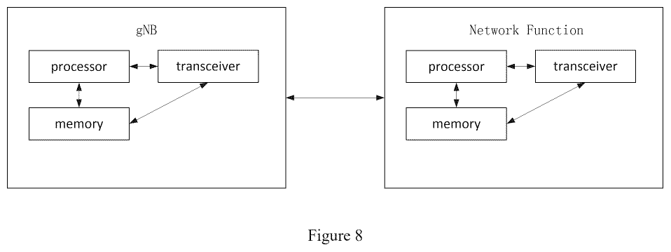

FIG. 8 is a schematic block diagram illustrating apparatuses according to one embodiment.

Referring to FIG. 8, the base station (e.g., gNB) includes a processor, a memory, and a transceiver that is a transmitter and/or a receiver. The processor implements a function, a process, and/or a method which are proposed in FIG. 6.

The base station comprises a transmitter that transmits, to a network apparatus, parameters necessary to determine an active number of reflecting elements at an RIS between the base station and a UE in an RIS-aided URLLC system; and a receiver that receives the active number of reflecting elements from the network apparatus. In one embodiment, the network apparatus is the NWDAF.

In one embodiment, the transmitter further transmits the active number of reflecting elements to the RIS.

In some embodiment, the parameters are for determining the active number of reflecting elements by applying DOR metric in the RIS-aided URLLC system. The parameters may include DOR requirement(s) of user group(s) and user traffic parameters. The user traffic parameters may include at least received SNR, the type of the traffic, required bandwidth, data rate, and the volume of transmitted data.

In some embodiment, the parameters are transmitted via an AMF.

The network apparatus (e.g., NWDAF) includes a processor, a memory, and a transceiver. The processor implements a function, a process, and/or a method which are proposed in FIG. 7.

The network apparatus comprises a receiver that receives, from the base station, parameters necessary to determine an active number of reflecting elements at an RIS between a base station and a UE in an RIS-aided URLLC system; a processor that determines the active number of reflecting elements according to the received parameters; and a transmitter that transmits the active number of reflecting elements to the base station.

In some embodiment, the parameters are for determining the active number of reflecting elements by applying DOR metric in the RIS-aided URLLC system. The parameters may include DOR requirement(s) of user group(s) and user traffic parameters. The user traffic parameters may include at least received SNR, the type of the traffic, required bandwidth, data rate, and the volume of transmitted data.

In some embodiment, the parameters are received via an AMF.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method performed by a base station, the method comprising:
transmitting, to a network apparatus, parameters necessary to determine an active number of reflecting elements at a Reconfigurable Intelligent Surface (RIS) between the base station and a user equipment (UE) in an RIS-aided ultra-reliable and low-latency communication (URLLC) system; and
receiving the active number of reflecting elements from the network apparatus.

2. The method of claim 1, further comprising:
setting the active number of reflecting elements to the RIS.

3. The method of claim 1, wherein, the parameters transmitted to the network apparatus comprises parameters for determining the active number of reflecting elements by applying delay outage rate (DOR) metric in the RIS-aided URLLC system.

4. The method of claim 3, wherein, the parameters transmitted to the network apparatus comprises DOR requirement(s) of user group(s) and user traffic parameters.

5. The method of claim 4, wherein, the user traffic parameters include at least received SNR, the type of the traffic, required bandwidth, data rate, and a volume of transmitted data.

6. The method of claim 1, wherein, the parameters are transmitted via an Access and Mobility management function (AMF).

7. The method of claim 1, wherein, the network apparatus is a network data analytics function (NWDAF).

8. (canceled)

9. (canceled)

10. (canceled)

11. (canceled)

12. (canceled)

13. (canceled)

14. A base station [,] comprising:
at least one memory;
a transceiver comprising a transmitter and a receiver;
at least one processor coupled with the at least one memory and with the transceiver and configured to cause the base station to:
transmit via the transmitter to a network apparatus, parameters necessary to determine an active number of reflecting elements at an RIS between the base station and a UE in an RIS-aided URLLC system to a network apparatus; and
receive, via the receiver from the network apparatus, the active number of reflecting elements.

15. (canceled)

16. The base station of claim 14, wherein further the at least one processor is configured to cause the base station to set the active number of reflecting elements to the RIS.

17. The base station of claim 14, wherein the parameters transmitted to the network apparatus comprises parameters for determining the active number of reflecting elements by applying delay outage rate (DOR) metric in the RIS-aided URLLC system.

18. The base station of claim 14, wherein the parameters transmitted to the network apparatus comprises DOR requirement(s) of user group(s) and user traffic parameters.

19. The base station of claim 18, wherein the user traffic parameters include at least received SNR, the type of the traffic, required bandwidth, data rate, and a volume of transmitted data.

20. The base station of claim 14, wherein the parameters are transmitted via an Access and Mobility management function (AMF).

21. The base station of claim 14, wherein the network apparatus is a network data analytics function (NWDAF).

22. A network apparatus comprising:
at least one memory;
a transceiver comprising a transmitter and a receiver;
at least one processor coupled with the at least one memory and with the transceiver and configured to cause the base station to:
receive, via the receiver from a base station, parameters necessary to determine an active number of reflecting elements at an RIS between a base station and a UE in an RIS-aided URLLC system;
determine the active number of reflecting elements according to the received parameters; and
transmit, via the transmitter to the base station, the active number of reflecting elements.

23. The network apparatus of claim 22, wherein the parameters comprise parameters utilized for determining the active number of reflecting elements by applying DOR metric in the RIS-aided URLLC system, and the at least one processor is further configured to cause the network apparatus to apply the DOR metric in determining the active number of reflecting elements.

24. The network apparatus of claim 22, wherein the parameters comprise DOR requirement(s) of user group(s) and user traffic parameters.

25. The network apparatus of claim 24, wherein the user traffic parameters comprise at least received SNR, a type of traffic, required bandwidth, data rate, and a volume of transmitted data.

26. The network apparatus of claim 22, wherein the parameters are received from the base station via an AMF.

27. The network apparatus of claim 22, wherein the apparatus is a network data analytics function (NWDAF).
